(19) United States
(12) Patent Application Publication
(10) Pub. No.: US 2019/0344423 A1
(43) Pub. Date: Nov. 14, 2019

(54) Ergonomic, multi-purpose, auxiliary handle assembly (tool attachment)

(71) Applicants: Robert James Doherty, Walpole, MA (US); Michael Thomas Doherty, Newton, MA (US); Charles Guaring, Newton, MA (US)

(72) Inventors: Robert James Doherty, Walpole, MA (US); Michael Thomas Doherty, Newton, MA (US); Charles Guaring, Newton, MA (US)

(21) Appl. No.: 15/974,511

(22) Filed: May 8, 2018

(51) Int. Cl. B25G 1/10; B25G 3/20

(52) U.S. Cl. CPC B25G 1/102; B25G 3/20

(57) ABSTRACT

An ergonomic, multi-purpose, attachable and adjustable, auxiliary handle assembly that provides a single supplementary handle for multiple tools and implements. The handle assembly is comprised of an “L”-shaped cylindrical bar that is combined with an adjustable yet lockable, hinged clamp that can be conveniently positioned along the primary cylindrical shaft of elongated tools and implements. This adjustable placement of this new auxiliary handle provides greater convenience in utilizing the tool to maximize its leverage or lifting capability while reducing the risk of muscular strain and fatigue. The adjustable feature allows operators of different sizes; tall to short, to conveniently place the adjustable handle on their tool or implement, at a position on the elongated shaft, that maximizes their preferred handling of the tool for operation. This auxiliary handle allows the user to maximize the effective use of the tool while reducing arm and back strain or injury. In addition to the ergonomic benefits, this new auxiliary handle provides multiple functional benefits for more effective lifting, pulling and pushing operation of tools and implements. In addition, the auxiliary handle enables operational use of tools and implements, with all the above-mentioned benefits, for both day and night use, given the convenient optional lighting component attached to the “L”-shaped handle that sheds light on the tool or implement head (where the head is the shovel, rake, hoe, broom or other tool end attachment).

### REFERENCES CITED

### US Patent Documents

U.S. Pat. No. 8,973,200 B23/2015 Mallett

U.S. Pat. No. 8,181,436 B15/2012 McMillan

U.S. Pat. No. 7,971,914 B17/2011 Pladson

U.S. Pat. No. 6,798,348 B19/2004 Wilker, et al.

U.S. Pat. No. 5,060,343 October 2091 Nisenbaum

U.S. Pat. No. 4,704,758 November 2087 Hoffman

U.S. Pat. No. 2,244,585 June 2041 Tweit

U.S. Pat. No. 1,083,054 December 2013 Brown

### BACKGROUND OF THE DISCLOSURE

### Field of the Disclosure

The disclosure relates to home, yard and commercial quality tools, specifically long-handled and more particularly pertains to a tool handle assembly that provides an attachable auxiliary handle that is adjustable for enabling more ergonomic and effective use of existing tools and implements including, but not limited to shovels (digging, trenching, spades, scrapers, roofing), rakes, hoes and brooms.

Common hand tools and implements are operated from a standing position and are used on a daily basis at home and at work. Typical examples of the use of these long handled tools are; to shovel snow, or dig holes to remove soil, or sweep the floor or ground, or for raking leaves. Each usage of a tool, whether for a short or prolonged period of time, can result in muscle fatigue and back injuries due to the nature of the users' posture and repetitive motions required when utilizing the tools.

Typically, the handle for a tool or implement is conventionally a straight elongated cylindrical shaft with the working part of the tool head at one end. The handle is typically where the operator places both their hands, one near the top and the other along the shaft of the handle, typically towards the bottom of the handle nearest the tool head, in order to get leverage to utilize the tool. The tool operator typically leans forward to grab and hold the tool according to the operators' physical height and posture. The extent of the operator's forward leaning results in the transmission of relatively large forces that are imposed on the hands and subsequently through the arms and shoulders and to the operator's upper and lower back. This can result in fatigue, strain and possible injury especially with heavy loads and prolonged use. In order to overcome this potential problem, the present invention provides an ergonomically designed, auxiliary tool handle which can provide improved leverage to enable safer use of the tool through a reduced distribution of the forces that can result in operator injury, yet enable improved lifting and digging capabilities.

### Description of Related Art

The prior art is replete with myriad handle constructions for diverse long handled implements such as shovels, lifting tools and the like. While all of the prior art constructions are adequate for their intended purpose and function, the various handle constructions are also normally restricted from a utilitarian standpoint to the specific task for which they had been developed, as can be seen is represented by the following references of interest.

U.S. Design Pat. No. 8,973,200 B2, issued on Mar. 10, 2015 to Mark Mallett, describes an ergonomic sweeping device designed for one-handed use, limited to brooms and sweeping devices. The designed dual handles are for convenient one-handed gripping for forward pushing of a broom or sweeping device. The one-handed design is specifically intended to enable the operator's second hand to be available for using a pan in conjunction with the one-handed operation of the broom, so that the operator can push debris into the pan or other collection device.

U.S. Design Pat. No. 8,181,436 B1, issued on May 22, 2012 to Robert L. McMillin, describes a specific handle assembly for rakes and hoes. This handle assembly is not generic and applicable for all elongated tools as it is designed for specific use with rakes and hoes. The described handle assembly does not provide firm gripping for lifting tool operation. The handle assembly described is restricted to specific operation, in that the operator would use his/her wrist to tightly grab near the top of the elongated tool shaft and the second grip provided would be for gripping a thin handle that specifically supports raking motions, not lifting or digging motions. With frequent use, this handle assembly can rotate on the cylindrical shaft as the tightened bolt loosens. This handle assembly is complex and not economically designed for cost-effective manufacture and production.

U.S. Design Pat. No. 7,971,914 B1, issued on Jul. 5, 2011 to James M. Pladson, describes a handle assembly with fastening members and grips that can become loose with frequent operation of the tool. The handle assembly is not designed for increasing the lifting, pulling or pushing capability of the tool. The handle design is primarily for ergonomic, reduced strained use of the tool.

U.S. Design Pat. No. 6,798,348 B1, issued on Sep. 28, 2004 to Scott Wilker et al, describes a tool handle with multiple bends, angularly positioned along the elongated cylindrical shaft for holding and operating the tool. This design is deficient because use of the tool is not effective (for operators with different physical statures). The tool handle is cumbersome to operate given the fixed and non-adjustable location of the bends for holding and operating the tool. Given the design and shape of the tool, it is also cumbersome to hang and store.

U.S. Design Pat. No. 5,060,343, issued on Oct. 29, 1991 to Philip Nisenbaum, describes an ergonomically designed tool handle that has a pair of perpendicularly extending hand grips secured at spaced locations along the handle. The tool handle includes a plurality of intersecting inclined portions which dispose the hand grips in various orientations, but are cumbersome to use. This tool handle is designed to replace the conventional elongated shaft of tools and implements to support multiple tool head attachments. This replacement handle is incompatible with current tools that are composed of an elongated shaft and an attached end tool which are produced and sold as a single unit. This replacement handle is also cumbersome to use and cumbersome to hang and store.

U.S. Design Pat. No. 4,704,758, issued on Nov. 10, 1987 to Charles W. Hoffman, describes a tool handle with multiple bends, angular positioned along the elongated cylindrical shaft for holding and operating a broom-specific tool. This tool handle is deficient because use of the tool is not effective for operators with different physical statures. This tool handle is cumbersome to operate given the fixed and non-adjustable location of the bends for holding and operating the tool. This tool handle is also cumbersome to hang and store.

U.S. Design Pat. No. 2,244,585, issued on Jun. 3, 1941 to Jacob M. Tweit, describes a tool handle that faces towards the top of the elongated shaft versus facing towards the bottom of the shaft and the tool end. The tool handle is not cylindrical, it is made of a flat curved bar that is bent to form a cylindrical clamp. The clamp uses a wing nut that tightens but does not lock and as a result can become loose with prolonged use. Tool handle is designed to effectively operate the tool or implement so that both hands of the operator will be at substantially the same height thereby eliminating the necessity of leaning forward when working with the tool or implement. However, to maximize leverage and lifting capability requires handle positioning that requires leaning forward with hands not necessarily at substantially the same level in order to get maximum leverage for lifting and digging operations, and maximum pressure for pushing brooms.

U.S. Design Pat. No. 1,083,054, issued on Dec. 30, 1913 to Leo Brown, describes a supplementary handle for shovels and like implements to afford greater lifting power, less labor and fatigue, greater convenience in manipulating the implement, handle is capable of a wide range of adjustments to regulate its leverage or lifting action. The handle clamping design has pointed teeth that are designed to be squeezed into the elongated shaft when the wing nut screw is tightened which can cause degradation of wood-composite handles and slippage and loosening on plastic or metallic elongated handles. The supplemental handle provides a small gripping surface that does not enable as firm a grip as a cylindrical supplemental handle where the fingers and thumb wrap around a cylindrical gripping surface for stronger gripping, holding and lifting capability.

Common to all the noted U.S. patents is the limitation to use during daylight given the absence of a lighting feature.

None of the above inventions or patents, taken either singularly or in combination, is seen to describe the instant invention as claimed.

Inasmuch as the art is relatively crowded with respect to the various types of tool handles, it can be appreciated that there is a continuing need for and interest in improvements to such tool handles, and in this respect, the present invention addresses this need and interest.

### SUMMARY OF THE DISCLOSURE

In view of the foregoing disadvantages inherent in the known types of tool handles now present in the prior art, the present invention provides a new and improved tool handle. As such, the general purpose of the present invention, which will be described subsequently in greater detail, is to provide a new and improved tool handle which has all the advantages of the prior art tool handles and none of the disadvantages. The present invention is to provide a new and improved tool handle which provides in the apparatuses and methods of the prior art some of the advantages thereof, while simultaneously overcoming many of the disadvantages normally associated therewith.

An embodiment of the disclosure meets the needs of enabling more ergonomic and effective use of elongated tools and implements by providing an ergonomically designed single auxiliary handle which provides greater leverage and positioning of the auxiliary handle on the tool or implement for the operator, of short or tall statures, to appropriately lean less forward to operate the tool, thereby reducing the fatigue, strain and possible injury to the arms, shoulders, upper and lower back of the operator.

### SUMMARY OF THE INVENTION

The present invention relates to a new and improved tool handle that can be attached to a tool or implement, more particularly to tools designed for use with two hands such as snow and dirt shovels, garden leaf and dirt rakes, hoes, spades, brooms and mops and the like which are operated from a standing position. The conventional form of these tools is typically composed of an elongated cylindrical handle which incorporates the working head of the tool located at the end of the elongated cylindrical handle. In order to use these tools the operator is required to place one hand near the top of the elongated handle and the second hand is placed, along the shaft, in a position the operator decides for enabling the best leverage for lifting up or pushing down the tool. The placement of this second hand requires the operator to lean over while using the tool. This can result in hand, arm and back strain especially if the operator uses the tool over an extended period of time.

Accordingly, it is a principal aspect of the invention to provide an auxiliary handle with an ergonomic design where the user places their second hand, on the positioned auxiliary handle allowing the operator to reduce the extent of leaning over and to provide more leverage that reduces back strain and muscle fatigue.

Another aspect of this invention to provide a new and improved tool handle that enables reliable one-time setup and secured/locked installation of the handle that enables continuous use of a tool or implement and eliminates the need for re-adjusting, re-tightening, or re-aligning the handle due to slippage, rotation, loosening of the handle or the handle's clamp or related bolts.

Another aspect of this invention is to provide a detachable and adjustable supplementary or auxiliary handle for use in conjunction with the handles of a multiplicity of tools; snow shovels, dirt shovels, garden rakes, brushes, brooms, mops, hoes and any other tools or implements with cylindrical elongated handles which are operated from a standing position. It is the aim of this invention to provide a supplementary or auxiliary handle which can be easily removed from one tool or implement to which it is attached for multiple re-use when it is moved and attached to other tools.

Yet another aspect of this invention to provide a new and improved tool handle that enables operators of a wide range of physical statures (tall, short, slim, heavy) to have convenience in manipulating a tool or implement because the handle is capable of a wide range of adjustments for effective placement of the handle along the tools elongated shaft to regulate its leverage or lifting action according to the stature of the operator.

Yet another aspect of this invention is the unique handle design and the dimensioned composition of galvanized, rust-proof, steel that is incorporated into the handle which affords greater lifting power and provides multiple functional benefits for more effective lifting, pulling and pushing operations of tools. It is the aim of this invention to provide an auxiliary handle which will be safe enough to withstand at least 300 pounds of weight in a single shovel without failing, bending breaking or becoming detached from the tool.

Yet another aspect of this invention is to provide support for both day and night use of tools and implements, given the convenient optional lighting component attached to the “L”-shaped handle that sheds light from the auxiliary handle towards the tool head (where the head is the shovel or rake or hoe or other end attachment) can now have better visibility for night operation of the tool.

Yet another aspect of this invention is to provide support for enabling convenient hanging and storage for tools and implements, given the design of the auxiliary tool handle that provides a “hook-like” feature for enabling convenient hanging of the tool on walls utilizing standard wall hooks for tools.

Yet another aspect of this invention to provide a new and improved tool handle which is of a durable and reliable construction materials, as a result of the unique handle design and the dimensioned composition of the galvanized, rust-proof, steel incorporated into the handle and the other assembly component parts.

Yet another aspect of this invention to provide a new and improved tool handle with a simplified design that enables a low cost of manufacture with regard to both materials and labor, and which accordingly is thus susceptible to low prices for sale to the consuming public, thereby making such tool handles economically available to the buying public.

These together with other aspects of the invention, along with the various features of novelty which characterize the invention, are pointed out with particularity in the claims annexed to and forming a part of this disclosure. For a better understanding of the invention, its operating advantages and the specific aspects attained by its uses, reference should be made to the accompanying drawings and descriptive matter in which there are illustrated preferred embodiments of the invention.

### DETAILED DESCRIPTION OF THE INVENTION

The present invention is an ergonomically designed auxiliary handle attachment. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings.

The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention appended hereto.

Other advantages of the invention will hereinafter become more fully apparent from the following description of the drawings, which illustrate a preferred embodiment thereof.

This invention is comprised of a cylindrical elongated curved or “L”-shaped tubing terminating in an adjustable hinged clamp that is can be attached as desired by the operator along the elongated tool handle, facing upward parallel to the elongated tool handle and pointing towards the end of the tool handle. The auxiliary handle assembly can be affixed to the elongated cylindrical shaft of the tool at any desired location along the along the length of the shaft of the tool.

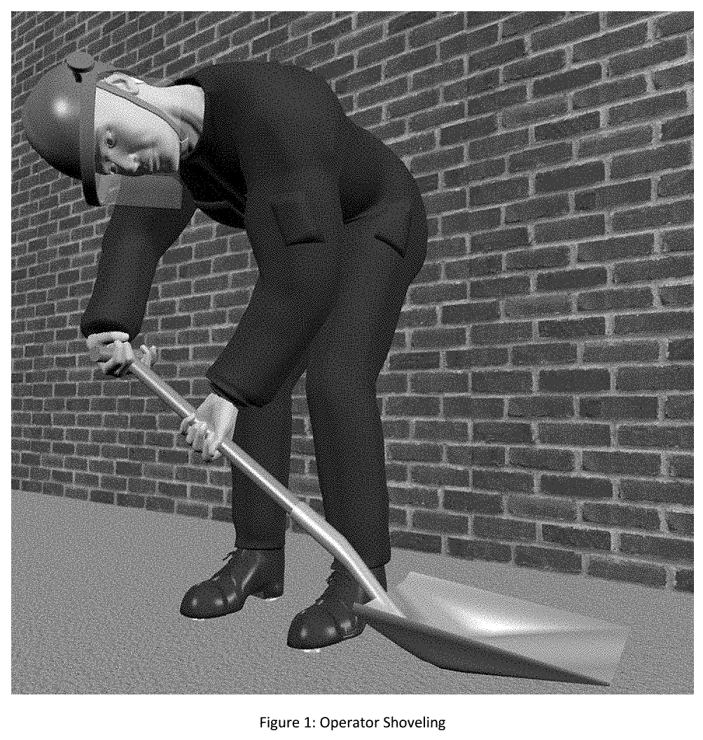

FIG. 1—Typical Operator Tool Posture—illustrates a typical posture for an average user operating an elongated tool (snow shovel in this example).

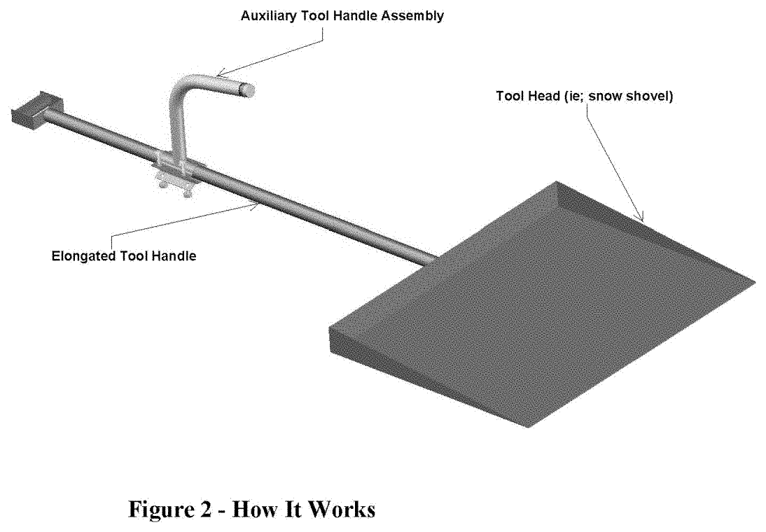

FIG. 2—How It Works—illustrates a typical attachment of the auxiliary handle attached to a typical elongated tool handle with a tool end, which in this case is a snow shovel. FIG. 2 shows the auxiliary tool handle assembly attached to a snow shovel whereby the handle is oriented pointing towards the working end of the shovel (tool head). This positioning enables the tool operator to grasp the auxiliary handle at a multiplicity of locations along the auxiliary handle tubing to enable the most effective control for utilizing the tool. This auxiliary handle positioning also enables the operator to utilize the supplied white LED light to enable utilization of the tool for nighttime operation.

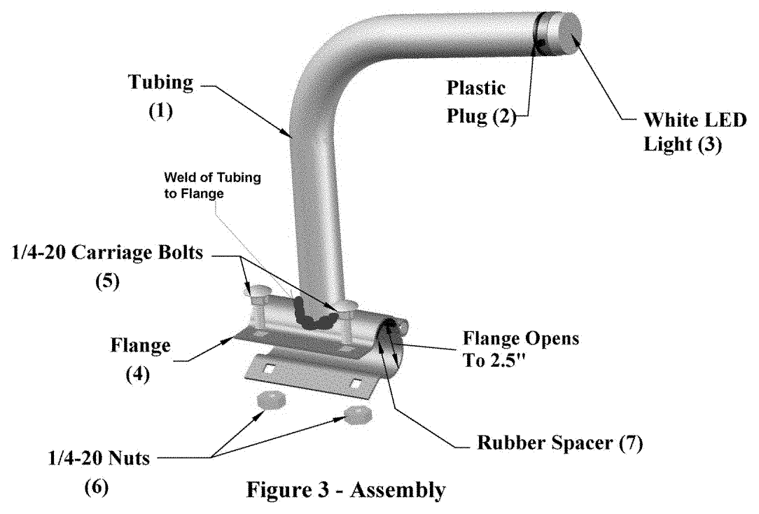

FIG. 3—Assembly—shows the auxiliary tool handle assembly components including; (1) Tubing (cylindrical, light-weight, rust-proof, galvanized steel tubing handle), (2) common 1 inch plastic plug inserted into the tubing to seal the tubing end, (3) Optional, LED Light accessory that can be affixed to the plastic cap, (4) common metal plumbers flange with square holes to support bolt locking. The metal flange is welded to the Tubing (1) (which has been cut to mate to the top side of the flange), (5) common carriage bolts with square neck for locking the flange for a compressed fit with adjacent bolts (6), and finally, (7) a standard 1×3× 1/16 inch thick Rubber Spacer to be inserted within the flange to prevent rotation of the attached auxiliary handle on the elongated cylindrical handle of the tool or implement.

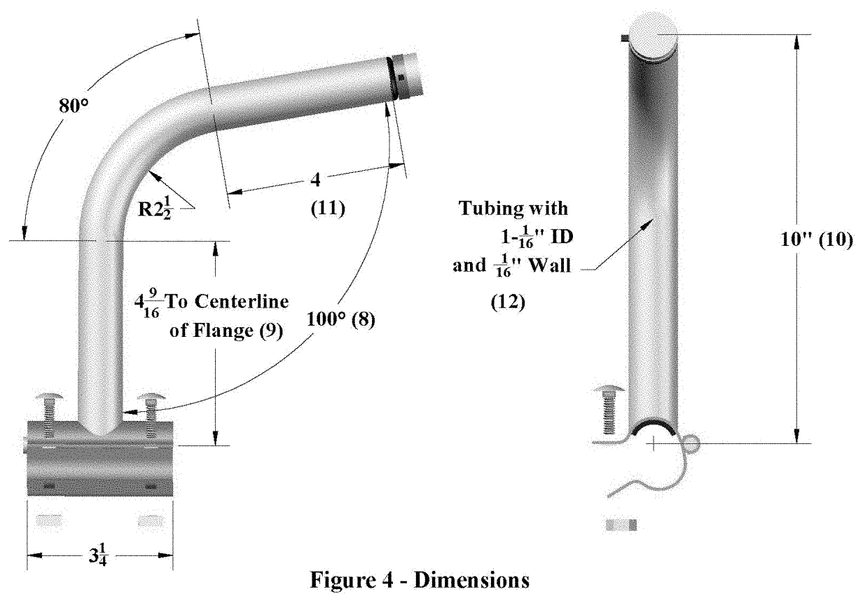

FIG. 4—Dimensions—shows detailed dimensions of the auxiliary tool assembly. Of particular note is the design of the 100 degree bend (8) of the Tubing which provides optimized gripping and leverage for the auxiliary handle when attached to an elongated tool handle. Also of particular note is the design of the length of the straight sections of the Tubing; (9) optimize height of 4 9/16 inches for elevating the auxiliary handle with a 10 inch parallel offset (10) from the elongated tool handle to enable optimized gripping and leverage for the auxiliary handle when attached to an elongated tool handle, (11) the primary gripping surface has an optimized length of 4 inches to support most effective gripping surface for variety of operator hand sizes. Also of particular note is the design of the 1 1/16 Steel Tubing diameter and 1/16 inch Wall thickness (12) for enabling optimized gripping and lifting capacity and strength.

The preferred embodiment of the auxiliary tool handle is composed of steel tubing approximately 14 inches in total length (before bending) whereby one end of the handle is welded to a metal hinged clamp shown as illustrated in FIG. 3. The auxiliary handle is linear for 4 9/16 inches from the welded region to the beginning of the bend on the Tubing. The Tubing is then bent 80 degrees (for approximately 3 inches of Tubing) and then is linear for another 4 inches of Tubing as is illustrated in FIG. 4. After the auxiliary handle is attached to an elongated tool handle, the auxiliary handle will be slightly above parallel to the tool handle at a distance of approximately 10 inches from the elongated tool handle. At the end of the auxiliary tool handle a plastic cap (2) that is inserted to seal the Tubing and provides an attachment surface for the LED light (3) which can be affixed to the plastic cap, as is illustrated in FIG. 3.

1. An ergonomic auxiliary handle assembly for attachment to an elongated tool, wherein a hinged mounting assembly attaches to an elongated tool or implement at a preferred location along the elongated tool handle, as is illustrated in FIG. 2. The preferred placement of the attached auxiliary handle accommodates a variety of operator physical statures and enables the operator to achieve optimized gripping of the tool with both hands from a standing position, given the multiplicity of gripping areas on the auxiliary handle for the operator. Of particular note is the angular design of the Tubing at 100 degrees which provides an optimal gripping height for the second hand of the operator. This combination of the optimized gripping surface and the optimal gripping height of the auxiliary handle from the elongated tool reduce hand, arm and back strain especially if the operator uses the tool over an extended period of time.

2. An ergonomic auxiliary handle assembly according to claim 1, wherein the auxiliary handle is, comprised of (as illustrated in FIGS. 3 and 4); a hinged mounting structure assembly comprised of Tubing (1) that is cylindrical, light-weight, rust-proof, and is composed of galvanized steel that is designed with specific dimensions to enable optimized gripping, maximized lifting capability and endurable longevity of the tubing. Of particular note is for the auxiliary handle's design to be safe enough to withstand at least 300 pounds of weight in a single shovel lifting operation without failing, bending breaking or becoming detached from the tool.

3. An ergonomic auxiliary handle assembly, as in any of the preceding claims, in which, the auxiliary handle is, (as illustrated in FIGS. 3 and 4); a hinged mounting structure assembly comprised of a common metal plumbers flange (4) with square holes to support bolt locking. The metal flange is welded to the Tubing (1) (which has been pre-cut to mate to the top side of the flange). The welding of the Tubing (1) to the flange (4) provides the most secure bond to ensure the optimized strength and endurance of the designed auxiliary handle.

4. An ergonomic auxiliary handle, as in any of the preceding claims, in which, the auxiliary handle is, comprised of (as illustrated in FIGS. 3 and 4); a hinged mounting structure assembly comprised of a rubber spacer (7) placed within the flange that gets compressed when the locking bolts are tightened, in order to prevent rotational movement or slippage of the auxiliary handle as attached to a cylindrical elongated tool or implement. The combination of the rubber spacer and the bolt locking of the auxiliary handle assembly bolts supports continuous use of a tool or implement while eliminating the need for re-adjusting, re-tightening, or re-aligning the handle due to slippage, rotation, loosening of the handle or loosening of the handle's clamp or related bolts, which is a noted deficiency in other related prior art.

5. An ergonomic auxiliary handle assembly, as in any of the preceding claims, in which, the auxiliary handle is, comprised of (as illustrated in FIGS. 3 and 4); a hinged mounting structure assembly comprised of a common 1 inch plastic plug (2) inserted into the tubing end to seal the tubing end and provide a surface for affixing other featured components in this design.

6. An ergonomic auxiliary handle assembly, as in any of the preceding claims, in which, the auxiliary handle is, comprised of (as illustrated in FIGS. 3 and 4); a hinged mounting structure assembly comprised of an LED Light (3) affixed to the plastic cap to provide support for both day and night use of tools and implements, given the optional LED lighting component that can be attached to the Tubing and sheds light from the auxiliary handle towards the tool head (where the head is the shovel or rake or hoe or other end attachment) can now have better visibility for night operation of the tool.

7. An ergonomic auxiliary handle assembly, as in any of the preceding claims, in which, the auxiliary handle provides a rapid, one-time setup and secured/locked attachment of the auxiliary handle to an elongated tool or Implement. As is illustrated in FIGS. 3 and 4; the auxiliary handle is comprised of hex carriage bolts that insert into the flange's square holes for locking the bolts via tightening of the supplied nuts. The bolts and nuts can be readily tightened with a common battery-powered drill for fast, convenient, one-time setup of the auxiliary handle assembly that secures it to the elongated handle preventing movement or shifting during use of the tool.

8. The ergonomic auxiliary handle assembly, as in any of the preceding claims, in which, the auxiliary handle is detachable and adjustable for use in conjunction with elongated handles of a multiplicity of tools; snow shovels, dirt shovels, garden rakes, brushes, brooms, mops, hoes and any other tools or implements with cylindrical elongated handles which are operated from a standing position. The auxiliary handle can be easily removed from the tool or implement to which it is attached in order to re-position the handle or to remove it entirely for use with another tool or implement.

9. The ergonomic auxiliary handle assembly, as in any of the preceding claims, in which, the auxiliary handle enables convenient hanging and storage for elongated tools and implements, given the design of the auxiliary tool handle which provides a “hook-like” design that enables convenient hanging of the tool on walls utilizing standard wall hooks or fixtures.

10. The ergonomic auxiliary handle assembly, as in any of the preceding claims, in which, the auxiliary handle provides a simplified design that enables a low cost of manufacture with regard to both materials and labor, given the common/standard components incorporated into the assembly design. The components included in the auxiliary handle assembly are thus susceptible to low prices for sale to the consuming public, thereby making such tool handles economically available to the buying public.
